(19) United States
(12) Patent Application Publication
(10) Pub. No.: US 2010/0271357 A1
(43) Pub. Date: Oct. 28, 2010

(54) PLASMA DISPLAY DEVICE

(75) Inventors: Hirofumi Honda, Osaka (JP); Takahiko Origuchi, Osaka (JP); Jun Kamiyamaguchi, Osaka (JP)

Correspondence Address: RATNERPRESTIA, P.O. BOX 980, VALLEY FORGE, PA, 19482, US

(73) Assignee: Panasonic Corporation, Oaska (JP)

(21) Appl. No.: 12/809,144

(22) PCT Filed: Nov. 19, 2009
(86) PCT No.: PCT/JP2009/006220

§ 371 Date: Jun. 18, 2010

(30) Foreign Application Priority Data
Nov. 21, 2008 (JP) 2008 297552

(51) Int. Cl. G06F 3/038

(52) U.S. Cl. 345/208

(57) ABSTRACT

A scan-pulse generating circuit has a shift resister section that has 2N (i.e. twice the number of the driving-voltage waveforms) resisters and shifts the data of the resisters; an N-bit latching section that retains output from every other resister of 2N resisters of the shift resister section and generates N control pulses for generating scan pulses; and switching section that generates scan pulses according to N control pulses.

### TECHNICAL FIELD

The present invention relates to a plasma display device as an image display device using a plasma display panel.

### BACKGROUND ART

An AC-type surface discharge plasma display panel has become dominance in plasma display panels (hereinafter referred to as a panel). In the panel, a plurality of discharge cells is formed between a front plate and a back plate oppositely disposed with each other.

The front plate has display electrode pairs—each pair is formed of a scan electrode and a sustain electrode—arranged in parallel with each other. The back plate has a plurality of data electrodes in a parallel arrangement. The front plate and the back plate are sealed with each other in a manner that the display electrode pairs are placed orthogonal to the data electrodes. A discharge space, which is formed between the front plate and the back plate, is filled with discharge gas. Discharge cells are formed at intersections of the display electrode pairs and the data electrodes.

In the typical panel operation, one-field period is divided into a plurality of subfields, which is known as a subfield method. According to the subfield method, gradation display on the panel is attained by combination of subfields to be lit. Each subfield has an initializing period, an address period and a sustain period.

In the initializing period, an initializing discharge occurs in the discharge cells. The initializing discharge generates wall charge on each electrode as a preparation for an address operation in the address period that follows the initializing period. In the address period, scan pulses are sequentially applied to the scan electrodes and address pulses are selectively applied to the data electrodes, so that an address discharge is selectively generated in the discharge cells to be lit. In the sustain period, sustain pulses suitable for luminance weight are alternately applied between the scan electrodes and the sustain electrodes of the display electrode pairs. The application of the sustain pulses generates a sustain discharge in a discharge cell having undergone an address discharge, allowing the cell to emit light.

The subfield method described above, however, has a problem in coping with a recent trend; in a recent panel with a larger screen and higher resolution than before, the scan electrodes increase in number, thereby increasing time required for address operations. The subfield method cannot obtain enough time for the sustain period for generating sustain discharge.

To address the problem above, a suggestion has been made, for example, in patent literature 1. The method introduces “simultaneous addressing” in which scan pulses are simultaneously applied to a plurality of scan electrodes, and at the same time, address pulses are selectively applied to the data electrodes. The simultaneous addressing allows the time required for the address period to be reduced, thereby maintaining the time required for the sustain period.

However, when the simultaneous addressing is carried out in a certain subfield (e.g. in a subfield with a small luminance weight), the vertical resolution of a certain image display decreases. Similarly, when the simultaneous addressing is carried out in a certain image display area, the vertical resolution of the image display area decreases, resulting in deterioration of image display quality.

To address the problems above, the structure needs an improved scan-electrode driving circuit capable of carrying out the simultaneous addressing in a certain subfield or in a certain image display area according to signals for image display.

### Patent Literature

patent literature 1; unexamined Japanese Patent Publication No. 2006-220902

### SUMMARY OF THE INVENTION

The plasma display device of the present invention has a panel having N scan electrodes (N represents natural numbers of 2 or greater) and a scan-pulse generating circuit generating scan pulses to be applied to each scan electrode and providing N driving-voltage waveforms. The scan-pulse generating circuit further contains a shift resister section that has 2N (i.e. twice the number of the driving-voltage waveforms) resisters and shifts the data of the resisters; an N-bit latching section that retains output from every other resister of 2N resisters of the shift resister section and generates N control pulses for generating scan pulses; and a switching section that generates scan pulses according to N control pulses.

### BRIEF DESCRIPTION OF THE DRAWINGS

FIG. 1 is an exploded perspective view showing the structure of the panel in accordance with a first exemplary embodiment of the present invention.

FIG. 2 shows an electrode layout of the panel in accordance with the first exemplary embodiment of the present invention.

FIG. 3 is a circuit block diagram of a plasma display device in accordance with the first exemplary embodiment of the present invention.

FIG. 4 is a detailed circuit diagram of a scan-electrode driving circuit in accordance with the first exemplary embodiment of the present invention.

FIG. 5 shows waveforms of driving voltage to be applied to each electrode of the panel in accordance with the first exemplary embodiment of the present invention.

FIG. 6 is a detailed circuit block diagram of a scan IC in accordance with the first exemplary embodiment of the present invention.

FIG. 7 is a table illustrating the control of the output control section in accordance with the first exemplary embodiment of the present invention.

FIG. 8 is a timing diagram illustrating how the scan IC works in accordance with the first exemplary embodiment of the present invention.

### REFERENCE MARKS IN THE DRAWINGS

10 panel
22 scan electrode
23 sustain electrode
24 display electrode pair
32 data electrode
40 plasma display device
41 image-signal processing circuit
42 data-electrode driving circuit
43 scan-electrode driving circuit
44 sustain-electrode driving circuit
45 timing-signal generating circuit
50 scan-pulse generating circuit
60 voltage setting circuit
62 sustain-pulse generator
63, 64 waveform generator
65 clamp section
72 shift resister section
74 latching section
76 output control section
78 switching section
QH1-QHN, QL1-QLN switching element

### DETAILED DESCRIPTION OF THE PREFERRED EMBODIMENTS

The plasma display device of an exemplary embodiment of the present invention is described hereinafter with reference to the accompanying drawings.

### First Exemplary Embodiment

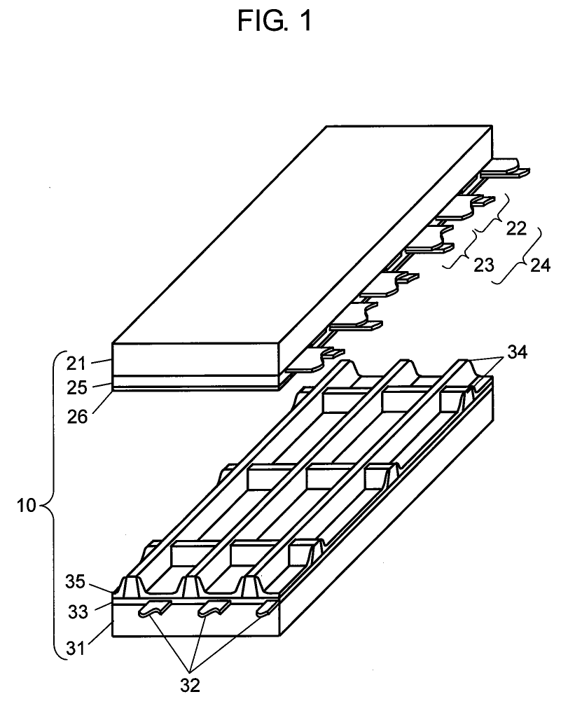

FIG. 1 is an exploded perspective view showing the structure of panel 10 in accordance with the first exemplary embodiment of the present invention. On glass-made front substrate 21, display electrode pairs 24—each pair is formed of scan electrode 22 and sustain electrode 23—are arranged, and over which, dielectric layer 25 and protective layer 26 are formed to cover display electrode pairs 24. On back substrate 31, data electrodes 32 are disposed, and over which, dielectric layer 33 is formed to cover data electrodes 32. On dielectric layer 33, barrier ribs 34 are formed in a grid arrangement. Phosphor layer 35, which is responsible for emitting light in red, green and blue, is formed on dielectric layer 33 and on the side surfaces of barrier ribs 34.

Front substrate 21 and back substrate 31 are oppositely disposed in a manner that display electrode pairs 24 are placed orthogonal to data electrodes 32 in a narrow discharge space between the two substrates. The two substrates are sealed at the peripheries with a sealing material such as glass frit. The discharge space is filled with discharge gas, for example, a gas containing xenon with a partial pressure of 10%. The discharge space is divided into sections by barrier ribs 34. Discharge cells are formed at intersections of display electrode pairs 24 and data electrodes 32. Generating discharge allows a discharge cell to emit light, so that an image appears on the panel.

Panel 10 does not necessarily have the structure above; the barrier ribs may be formed into stripes.

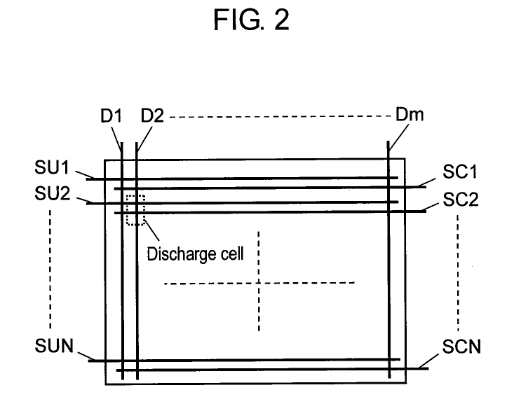

FIG. 2 shows arrangement of the electrodes on panel 10 in accordance with the embodiment. In the horizontal direction, panel 10 has N long scan electrodes SC1-SCN (corresponding to scan electrodes 22 in FIG. 1) and N long sustain electrodes SU1-SUN (corresponding to sustain electrodes 23 in FIG. 1). In the vertical direction, panel 10 has M long data electrodes D1-DM (corresponding to data electrodes 32 in FIG. 1). A discharge cell is formed at an intersection of a pair of scan electrode SCi and sustain electrode SUi (where, i takes 1 to N) and data electrode Dj (where, j takes 1 to M). That is, panel 10 contains M×N discharge cells in the discharge space. The number of the scan electrodes (represented by N) depends on the specifications of panel 10; N=768 for a high-definition panel, N=1080 for a full spec high-definition panel.

Hereinafter, the structure and workings of the plasma display device of the embodiment will be described.

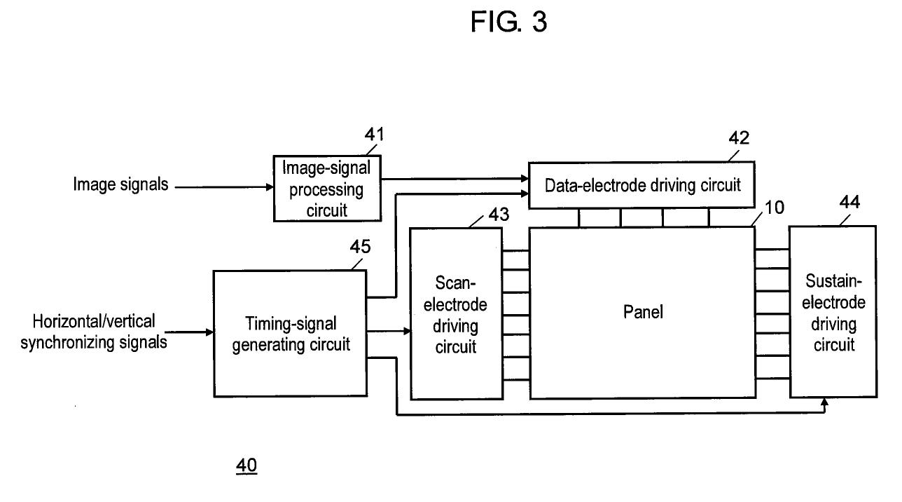

FIG. 3 is a circuit block diagram of plasma display device 40 of the embodiment. Plasma display device 40 has panel 10, image-signal processing circuit 41, data-electrode driving circuit 42, scan-electrode driving circuit 43, sustain-electrode driving circuit 44, timing-signal generating circuit 45, and a power supply circuit (not shown) for delivering power to each circuit block.

Image-signal processing circuit 41 converts incoming image signals into the image signals suitable for the number of pixels and gradation levels of panel 10, and further converts them to image data in which emission and non-emission of each subfield are represented by binary bits of digital signals (i.e. 1 or 0), respectively. Receiving the image data, data-electrode driving circuit 42 converts them into address pulses for data electrodes D1-DM for driving the electrodes with application of the address pulses.

Timing-signal generating circuit 45 generates timing signals that control each circuit block according to a horizontal synchronizing signal and a vertical synchronizing signal, and the timing signals are fed to each circuit block. Besides, timing-signal generating circuit 45 determines the addressing manner (i.e., either single addressing or simultaneous addressing, which will be described later) in the address period.

According to the timing signals, scan-electrode driving circuit 43 and sustain-electrode driving circuit 44 generate driving voltage waveforms suitable for respective electrodes so as to apply the waveforms to scan electrodes SC1-SCN, and sustain electrodes SU1-SUN.

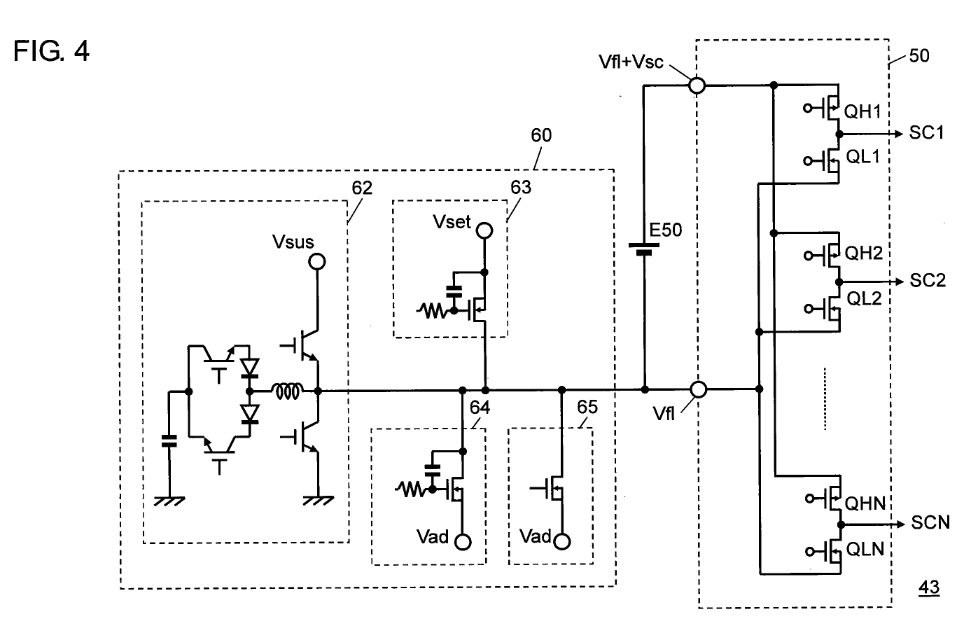

FIG. 4 is a detailed circuit diagram of scan-electrode driving circuit 43 in accordance with the first exemplary embodiment of the present invention. Scan-electrode driving circuit 43 has scan-pulse generating circuit 50, power supply E50, and voltage setting circuit 60. Power supply E50 carries voltage Vsc that is added on reference voltage Vf1 of scan-pulse generating circuit 50. Voltage setting circuit 60 sets reference voltage Vf1 to a predetermined voltage described below.

Scan-pulse generating circuit 50 has switching sections for applying scan pulses to each of scan electrodes SC1-SCN and control circuit blocks corresponding to the switching sections. With the structure above, the driving voltage waveforms are applied to scan electrodes SC1-SCN. The switching sections have switching elements QL1-QLN and QH1-QHN. Switching elements QL1-QLN output voltage on the lower-voltage side of power supply E50 i.e. reference voltage Vf1. Switching elements QH1-QHN output voltage on the higher-side of power supply E50 i.e. voltage Vsc added on reference voltage Vf1. The control circuit blocks of switching elements QL1-QLN and QH1-QHN are not shown in FIG. 4.

Voltage setting circuit 60 has sustain-pulse generator 62, waveform generators 63 and 64, and clamp section 65. Sustain-pulse generator 62 outputs voltage Vsus or voltage of zero (0V) and generates sustain pulses. Waveform generator 63 has a Miller integrating circuit connected to power supply carrying voltage Vset and generates an up-ramp waveform that gradually increases toward voltage Vset. Waveform generator 64 has a Miller integrating circuit connected to power supply carrying negative voltage Vad and generates a down-ramp waveform that gradually decreases toward voltage Vad. Clamp section 65 clamps reference voltage Vf1 of scan-pulse generating circuit 50 onto negative voltage Vad.

Such structured voltage setting circuit 60 allows reference voltage Vf1 of scan-pulse generating circuit 50 to be set to various level: voltage Vad, voltage Vsus, voltage of zero (0V), up-ramp voltage, and down-ramp voltage.

The structure above has, although FIG. 4 does not show, a switching element for preventing backflow of current and a diode for bypassing current as required.

Next, the method for driving panel 10 will be described. Panel 10 attains gradation display by a subfield method. In the subfield method, one-field period is divided into a plurality of subfields. Light-emitting control of the discharge cells is carried out on a subfield basis. Each subfield has an initializing period, an address period and a sustain period.

In the initializing period, an initializing discharge is generated to form wall charges on each electrode as a preparation for an address discharge to be generated in the address period. In the address period, scan pulses are applied to the scan electrodes, and at the same time, address pulses are selectively applied to the data electrodes so as to selectively cause an address discharge in a discharge cell to be lit and form wall charges. In the sustain period, sustain pulses suitable for luminance weight are alternately applied to the display electrode pairs so that a sustain discharge is generated in the discharge cell having undergone an address discharge for light emission.

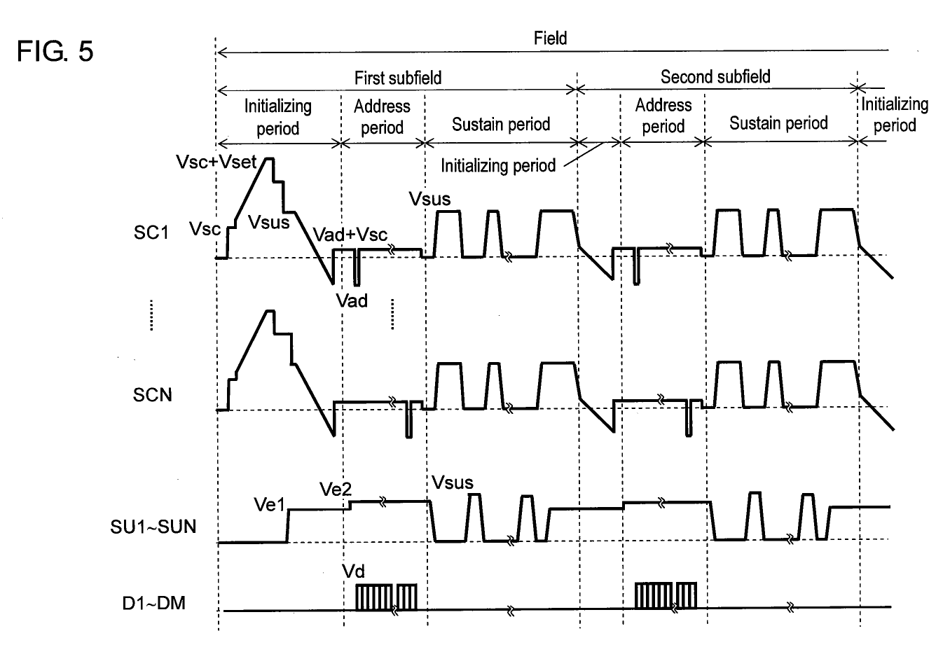

FIG. 5 shows driving voltage waveforms applied to each electrode of panel 10 for two subfields.

In the first half of the initializing period, voltage of zero (0V) is applied to data electrodes D1-DM and sustain electrodes SU1-SUN. Reference voltage Vf1 is set to voltage of zero (0V) by sustain-pulse generator 62, and switching elements QH1-QHN of scan-pulse generating circuit 50 are turned on, by which voltage Vsc is applied to scan electrodes SC1-SCN. Next, waveform generator 63 applies up-ramp voltage, which is gradually increasing toward voltage Vset+Vsc, to scan electrodes SC1-SCN. During the gradual increase of the up-ramp voltage, a weak initializing discharge occurs between scan electrodes SC1-SCN, sustain electrodes SU1-SUN and data electrodes D1-DM, and wall voltage is built up on each electrode. The wall voltage above represents a voltage generated by wall charges built up on dielectric layer 33, protective layer 26, and phosphor layer 35 on the electrodes.

In the latter half of the initializing period, positive voltage Ve1 is applied to sustain electrodes SU1-SUN. Reference voltage Vf1 is set to voltage Vsus by sustain-pulse generator 62, and switching elements QH1-QHN are turned off, whereas switching elements QL1-QLN are turned on, by which voltage Vsus is applied to scan electrodes SC1-SCN. After that, waveform generator 63 applies a down-ramp voltage, which is gradually decreasing toward voltage Vad, to scan electrodes SC1-SCN. During the application of voltage, a weak initializing discharge occurs again, by which wall voltage on each electrode is adjusted to a value suitable for the address operation.

As the initializing operation, only applying gradually decreasing ramp voltage to scan electrodes SC1-SCN in the latter half of the initializing period is also effective, as is shown in the initializing period in the second subfield of FIG. 5.

In the address period, voltage Vet is applied to sustain electrodes SU1-SUN. Clamp section 65 clamps reference voltage Vf1 onto negative voltage Vad, and at the same time, switching elements QH1-QHN are turned on, by which voltage Vad+Vsc is applied to scan electrodes SC1-SCN.

Next, scan pulses are applied to the scan electrodes, and at the same time, address pulses are selectively applied to the data electrodes. The application of the pulses selectively causes an address discharge in a discharge cell and forms wall voltage. In the embodiment, the scan pulses are not always applied to each of scan electrodes SC1-SCN one-by-one basis; the scan pulses may be applied to two scan electrodes at the same time according to the control of timing-signal generating circuit 45. Hereinafter, an example will be described.

For example, switching element QH1 is turned off and switching element QL1 is turned on. Through the switching control, scan pulses with voltage Vad are applied to scan electrode SC1 in the first row. Next, positive address pulse voltage Vd is applied to data electrode Dk (k=1 to M) that corresponds to the discharge cell to be lit in the first row. An address discharge occurs in a discharge cell having undergone the application of address pulse voltage in the first row, whereas no address discharge occurs in a discharge cell with no application of address pulse voltage Vd. Selective address operation is thus carried out. After that, switching element QH1 is turned on and switching element QL1 is turned off. As described above, the address operation by applying the scan pulses to a single scan electrode is referred to “single addressing” in the description. The time required for the addressing is referred to “addressing cycle”, and it is set to 1.0 μs in the embodiment. The addressing cycle should preferably be set to an optimal value according to characteristics of panel 10, for example, the discharge characteristic.

Next, for example, switching elements QH2 and QH3 are turned off and switching elements QL2 and QL3 are turned on. Through the switching control, scan pulses with voltage Vad are applied to scan electrode SC2 in the second row and scan electrode SC3 in the third row. Next, address pulse voltage Vd is applied to data electrode Dk in data electrodes D1-DM (where, data electrode Dk corresponds to the discharge cell to be lit in the second and third rows). The application of the voltage selectively causes an address discharge in a discharge cell in the second and third rows. After that, switching elements QH2 and QH3 are turned on and switching elements QL2 and QL3 are turned off. The address operation described above is referred to “simultaneous addressing” in the embodiment. In the simultaneous addressing, the scan pulses are applied to more-than-one scan electrode at the same time.

The simultaneous addressing allows the address operation to carry out on two scan electrodes in one addressing cycle, shortening the time required for address operation in half. However, the discharge cells that share data electrode Dk also share the same address pulses, which lowers vertical resolution of the panel.

Similarly, to carry out the simultaneous addressing on scan electrodes SC4 and SC5, switching elements QH4 and QH5 are turned off and switching elements QL4 and QL5 are turned on. After completion of address discharge, switching elements QH4 and QH5 are turned on and switching elements QL4 and QL5 are turned off.

Further, to carry out the single addressing on scan electrode SC6, switching element QH6 is turned off and switching element QL6 is turned on. After completion of address discharge, switching element QH6 is turned on and switching element QL6 is turned off.

In this way, the address operation is carried out until the discharge cells in Nth row in a manner that, for example, scan electrode SCh (h=1 to N) undergoes the single addressing or scan electrodes SCh and SCh+1 undergo the simultaneous addressing.

After that, reference voltage Vf1 is set to voltage of zero (0V) by sustain-pulse generator 62 and switching elements QL1-QLN are turned on so that voltage of zero (0V) is applied to scan electrodes SC1-SCN.

In the sustain period that follows the address period, voltage of zero (0V) is applied to sustain electrodes SU1-SUN and sustain pulses with voltage Vsus are applied to scan electrodes SC1-SCN by sustain-pulse generator 62. The application of voltage allows a sustain discharge to be generated in the discharge cell having undergone an address discharge. Next, voltage of zero (0V) is applied to scan electrodes SC1-SCN and sustain pulses with voltage Vsus are applied to sustain electrodes SU1-SUN. The application of voltage allows a sustain discharge to be generated again in a discharge cell having undergone a sustain discharge.

In the same manner, scan electrodes SC1-SCN and sustain electrodes SU1-SUN alternately undergo sustain pulses (where the number of the pulses to be applied are determined according to a luminance weight), providing difference in potential between a scan electrode and a sustain electrode as a display electrode pair. This allows the sustain discharge to repeatedly generate in a discharge cell having undergone an address discharge in the address period.

The subfields successive to the aforementioned two subfields have operations almost the same as that described above, except for the number of sustain pulses, and therefore the descriptions thereof will be omitted.

In the embodiment, voltage to be applied to each electrode has the following values: 330 V for voltage Vset; 190 V for voltage Vsus; 140 V for voltage Vsc; −180 V for voltage Vad; 160 V for voltage Ve1; 170 V for voltage Ve2; and 60 V for voltage Vd. These values are cited merely by way of example and without limitation; they should be properly determined according to characteristics of panel 10 and specifications of plasma display device 40.

According to the embodiment, as described above, the scan pulses are not always applied to each of scan electrodes SC1-SCN one-by-one basis; the scan pulses may be applied to two scan electrodes at the same time as required.

Next, aforementioned scan-pulse generating circuit 50 will be described in detail. Scan-pulse generating circuit 50 has switching sections and control circuit blocks corresponding to the switching sections. The switching sections have switching elements QH1-QHN and QL1-QLN for scan electrodes SC1-SCN, respectively. That is, scan electrodes SC1 is provided with switching elements QH1, QL1 and a control circuit block thereof, scan electrode is provide with switching elements QH2, QL2 and a control circuit block thereof, . . . , scan electrode SCN is provided with switching elements QHN, QLN and a control circuit thereof.

The control circuit block of a switching section of the embodiment has a shift resister section, a latching section, and an output control section.

According to the embodiment, N switching elements QLi and QHi and the control circuit block thereof are grouped into n integrated-circuit structures. Hereinafter, each integrated-circuit structure is referred to a “scan IC”. Here in the embodiment, n (=68) switching elements and respective control circuit blocks constitute one scan IC; scan-pulse generating circuit 50 has 16 scan ICs having n (=68) outputs and applies scan pulses to N (=1080) scan electrodes (i.e. scan electrodes SC1-SC1080). Employing an IC structure allows scan-pulse generating circuit 50 with a plurality of outputs to be compact, saving the area for installation.

As described above, scan-pulse generating circuit 50 of the embodiment is formed of a plurality of scan ICs. Hereinafter, the structure of the scan IC applying driving voltage waveforms to scan electrodes SC1-SC68 will be described in detail. As for the rest of the scan electrodes, i.e., scan electrodes SC69-SC1080, similarly structured scan IC applies the driving voltage waveforms to them.

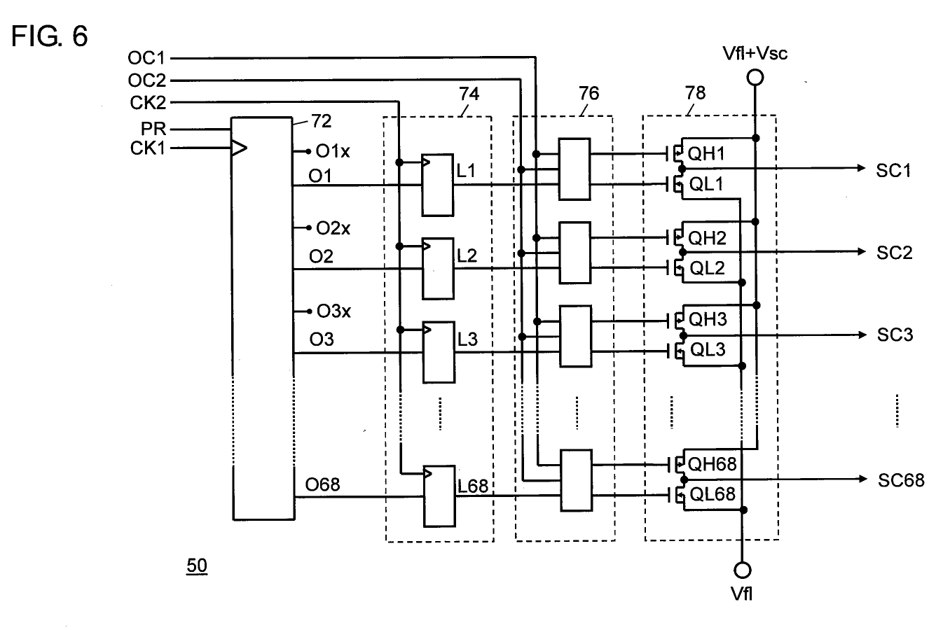

FIG. 6 is a detailed circuit block diagram of a scan IC in accordance with the first exemplary embodiment of the present invention. As described above, each of scan ICs has shift resister section 72, latching section 74, output control section 76, and switching section 78.

Shift resister section 72 has 2n resisters (where, n represents the number of output) and shifts the data of the resisters. According to the embodiment, one scan IC generates scan pulses for 68 scan electrodes; the resister of the embodiment is a 136-bit shift resister. In the embodiment, the outputs of the 136-bit resister are referred to O1x, O1, O2x, O2, . . . , O68x, and O68 in the sequential order from the first output.

Shift resister section 72 has a clock-input terminal (which will be described later in detail) to which clock signal CK1 with any one of two, three, and four in number are fed in one addressing cycle. The number of incoming clock signals CK1 is controlled by the single addressing or the simultaneous addressing. Shift resister section 72 also has preset-input terminal PR that presets a level of the output from shift resister section 72. When shift resister section 72 receives clock signal CK1 at ‘H’ level of preset signal PR, the outputs of shift resister section 72 are determined such that the first three outputs are preset to ‘L’ level and the rest of them are preset to ‘H’ level, i.e., ‘L, L, L, H, H’,

Latching section 74 retains every other output from the outputs of 2n resisters of shift resister section 72 and generates n control pulses for scan pulses. Receiving clock signal CK2, latching section 74 of the embodiment retains even-numbered outputs (i.e., O1, O2, . . . , O68) from shift resister section 72 into a 68-bit latch. Clock signal CK2 has a cycle equivalent to the addressing cycle. Hereinafter, the 68-bit outputs of latching section 74 are referred to control pulses L1, L2, . . . , L68.

Output control section 76 receives control pulse L1 from latching section 74 and two control signals OC1, OC2, and effects control of switching elements QHi and QLi (corresponding to control pulse L1) of switching section 78.

Switching section 78 generates scan pulses according to each of the control pulses. Switching section 78 of the embodiment has switching elements QH1-QH68 that output voltage on the higher voltage side of power supply E50 and switching element QL1-QL68 that output voltage on the lower voltage side of power supply E50. Switching section 78 effects on/off control of switching elements QH1-QH68 and QL1-QL68 according to output control section 76, and outputs any one of high impedance, reference voltage Vf1 and voltage Vsc added on reference voltage Vf1.

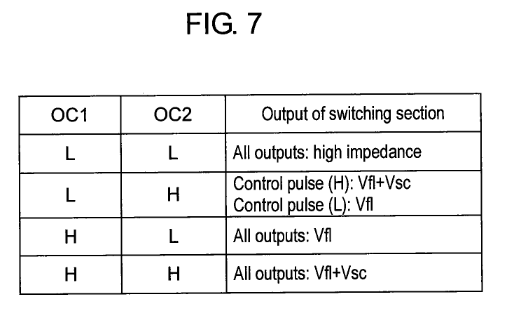

FIG. 7 is a table illustrating the control of output control section 76 in accordance with the first exemplary embodiment of the present invention. According to two control signals OC1, OC2 and control pulses L1-L68, output control section 76 effects control of switching elements QH1-QH68 and QL1-QL68 as follows.

When both of control signals OC1 and OC2 show ‘L’ level, all of switching elements QH1-QH68 and QL1-QL68 are turned off, and all of the outputs are set on a high impedance condition;

When control signal OC1 shows ‘L’ level and control signal OC2 shows ‘H’ level, switching elements QHi and QLi are controlled by corresponding control pulse L1 of latching section 74. In the embodiment, when control pulse L1 as the i^{th} pulse of latching section 74 shows ‘H’ level, switching element QHi is turned on and switching element QLi is turned off. When control pulse L1 shows ‘L’ level, switching element QHi is turned off and switching element QLi is turned on.

When control signal OC1 shows ‘H’ level whereas control signal OC2 shows ‘L’ level, switching elements QH1-QH68 are turned off and switching elements QL1-QL68 are turned on regardless to the corresponding control pulses of latching section 74, so that switching section 78 outputs reference voltage Vf1.

When both of control signals OC1 and OC2 show ‘H’ level, switching elements QH1-QH68 are turned on and switching elements QL1-QL68 are turned off regardless to the corresponding control pulses of latching section 74, so that switching section 78 outputs voltage Vsc added on reference voltage Vf1.

Next, the workings of scan-pulse generating circuit 50 will be described. According to the embodiment, scan-pulse generating circuit 50 is formed of a plurality of scan ICs. Hereinafter, the structure of the scan IC applying driving voltage waveforms to scan electrodes SC1-SC68 will be described in detail. As for the rest of the scan electrodes, i.e., scan electrodes SC69-SC1080, similarly structured scan IC applies the driving voltage waveforms to them.

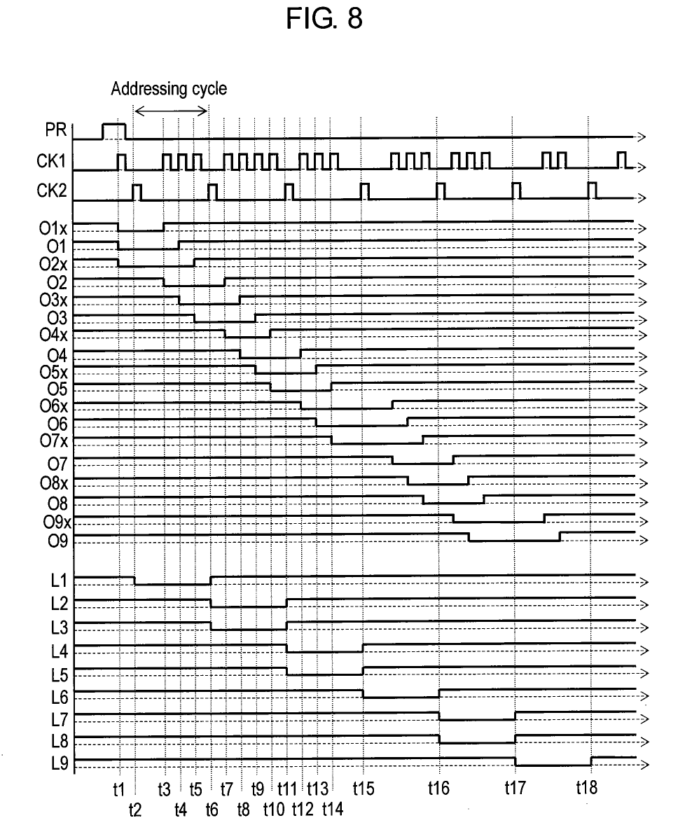

FIG. 8 is a timing diagram illustrating how the scan IC works in accordance with the first exemplary embodiment of the present invention. The scan pulses are applied to the scan electrodes with the timing described below:
in the first addressing cycle (time t2-time t6), scan pulses are applied to scan electrode SC1;
in the second addressing cycle (time t6-time t11), scan pulses applied to scan electrodes SC2 and SC3 at the same time
in the third addressing cycle (time t11-time t15), scan pulses applied to scan electrodes SC4 and SC5 at the same time;
in the fourth addressing cycle (time t15-time t16), scan pulses are applied to scan electrode SC6;
in the fifth addressing cycle (time t16-time t17), scan pulses are applied to scan electrodes SC7 and SC8 at the same time; and in the sixth addressing cycle (time t17-time t18), scan pulses are applied to scan electrode SC9.

Hereinafter, the workings of the scan IC with reference to the timing diagram.

At time t1, clock signal CK1 is fed into shift resister section 72 with preset signal PR being set at ‘H’ level. The outputs of shift resister section 72 i.e. O1x, O1, O2x, O2, O3x, O3, O4x, O4, . . . , O68 are preset to ‘L, L, L, H, H, H, H, H, . . . , H’. In response to the input of clock signal CK2 at time t2, control pulse L1 of latching section 74 shows level and control pulses L2-L68 show ‘H’ level, so that scan pulses are applied to scan electrode SC1 in the first addressing cycle.

Next, clock signal CK1 is fed at time t3 and then at time t4. In response to the clock signal, the outputs of shift resister section 72 are set to ‘H, H, L, L, L, H, H, H, . . . , H’. At time t5, to carry out simultaneous addressing in the second addressing cycle, clock signal CK1 is fed to shift resister section 72. In response to the clock signal, the outputs of shift resister section 72 are set to ‘H, H, H, L, L, L, H, H, . . . , H’. After that, clock signal CK2 is fed to latching section 74 at time t6. In response to the clock signal, control pulses L2 and L3 of latching section 74 are set at ‘L’ level whereas control pulses L4-L68 are set at ‘H’ level, so that scan pulses are applied to scan electrodes SC2 and SC3 in the second addressing cycle. Next, at time t7, clock signal CK1 is fed to shift resister section 72. In response to the clock signal, the outputs of shift resister section 72 are set to ‘H, H, H, H, L, L, L, H, . . . , H’.

Next, clock signal CK1 is fed at time t8 and then at time t9. In response to the clock signal, the outputs of shift resister section 72 are set to ‘H, H, H, H, H, H, L, L, L, H, . . . , H’. At time t10, to carry out simultaneous addressing in the third addressing cycle, clock signal CK1 is fed to shift resister section 72. In response to the clock signal, the outputs of shift resister section 72 are set to ‘H, H, H, H, H, H, H, L, L, L, H, . . . , H’. After that, clock signal CK2 is fed to latching section 74 at time M. In response to the clock signal, control pulses L4 and L5 of latching section 74 are set at ‘L’ level whereas control pulses L1-L3 and L6-L68 are set at ‘H’ level, so that scan pulses are applied to scan electrodes SC4 and SC5 in the third addressing cycle. Next, at time t12, clock signal CK1 is fed to shift resister section 72. In response to the clock signal, the outputs of shift resister section 72 are set to ‘H, H, H, H, H, H, H, H, L, L, L, H, . . . , H’.

Next, clock signal CK1 is fed at time t13 and then at time t14. In response to the clock signal, the outputs of shift resister section 72 are set to ‘H, H, H, H, H, H, H, H, H, H, L, L, L, H, . . . , H’. Simultaneous addressing is not carried out in the fourth addressing cycle and therefore no more input of clock signal CK1. At time t15, clock signal CK2 is fed to latching section 74. In response to the clock signal, control pulses L6 of latching section 74 is set at ‘L’ level whereas control pulses L1-L5 and L7-L68 are set at ‘H’ level, so that scan pulses are applied to scan electrode SC6 in the sixth addressing cycle.

In the same manner, when single addressing is carried out, two clock signals CK1 are fed in an addressing cycle, and after that, clock signal CK2 is fed into latching section 74. When simultaneous addressing is carried out, two clock signals CK1 are fed in an addressing cycle, and further clock signal CK1 is fed in the cycle. After that, clock signal CK2 is fed into latching section 74 and then clock signal CK1 is fed into shift resister section 72.

That is, the addressing operations can be controlled by the number of the clock signals.

To continue the single addressing, two clock signals CK1 are fed in the addressing cycle. This allows shift resister section 72 to have 2-bit shifting on the outputs. To continue the simultaneous addressing, four clock signals CK1 are fed in the addressing cycle. This allows shift resister section 72 to have 4-bit shifting on the outputs. To change the single addressing to the simultaneous addressing, three clock signals CK1 are fed in the addressing cycle just before the intended simultaneous-addressing cycle. This allows shift resister section 72 to have 3-bit shifting on the outputs. To change the simultaneous addressing to the single addressing, three clock signals CK1 are fed in the addressing cycle just before the intended single-addressing cycle. This allows shift resister section 72 to have 3-bit shifting on the outputs.

As described above, controlling the number of clock signals CK1 to be fed into shift resister section 72 determines either the single addressing or the simultaneous addressing on a scan electrode in a subfield. The input timing of clock signal CK1 has no specific limitation as long as it is set in a normal working range of the circuits.

The structure of the embodiment, as described above, has shift resister section 72 having 2n resisters (where n represents the number of scan pulses to be applied). Whether a scan electrode in a subfield undergoes the single addressing or the simultaneous addressing depends on the number of clock signal CK1 to be fed into shift resister section 72 in an addressing cycle. In the embodiment, shift resister section 72 is preset by input of preset signal PR at the start of an address period, but it is not limited thereto; shift resister section 72 can be preset by, for example, receiving serial data through a serial data input terminal.

The structure of the embodiment has been described in detail on scan-pulse generating circuit 50 formed of a plurality of scan ICs. However, scan-pulse generating circuit 50 is not necessarily formed into the structure above; the present invention is also applicable to a scan-pulse generating circuit as long as it has the following structure: a shift resister section that has 2N resisters (where N represents the number of driving-voltage waveforms) and shifts the data of the resisters; an N-bit latching section that retains output from every other resister of 2N resisters of the shift resister section and generates N control pulses for generating scan pulses; and a switching section that generates scan pulses according to N control pulses.

In the description of the embodiment, numeric values are cited merely by way of example and without limitation; they should be properly determined according to characteristics of a panel and specifications of a plasma display device.

### INDUSTRIAL APPLICABILITY

The structure of the present invention with a relatively simple circuit structure provides simultaneous address operation in a certain subfield and in a certain image display area. It is therefore useful for a plasma display device.

1. A plasma display device comprising:
a plasma display panel that contains N scan electrodes (where, N represents natural numbers of 2 or greater); and
a scan-pulse generating circuit that generates scan pulses to be applied to each scan electrode and provides N driving voltage waveforms, the scan-pulse generating circuit further including:
a shift resister section that has 2N (i.e., twice the number of the driving voltage waveforms) resisters and shifts data of the resisters;
an N-bit latching section that retains output from every other resister of the 2N resisters of the shift resister section and generates N control pulses for generating the scan pulses; and
a switching section that generates the scan pulses according to the N control pulses.

2. The plasma display device of claim 1, wherein the scan-pulse generating circuit is formed of a plurality of ICs having n outputs (where, n represents natural numbers smaller than N),
each of the ICs including:
a shift resister section that has 2n (i.e., twice the natural numbers n) resisters and shifts data of the resisters;
an n-bit latching section that retains output from every other resister of the 2n resisters of the shift resister section and generates n control pulses for generating the scan pulses; and
a switching section that generates the scan pulses according to the n control pulses.
